(19) United States
(12) Patent Application Publication
(10) Pub. No.: US 2003/0084005 A1
(43) Pub. Date: May 1, 2003

(54) Product selling and pricing system and method

(75) Inventors: Yoon Kean Wong, Menlo Park, CA (US); David Kammer, Seattle, WA (US); David Z. Creemer, Palo Alto, CA (US)

Correspondence Address: FOLEY & LARDNER, 777 EAST WISCONSIN AVENUE, SUITE 3800, MILWAUKEE, WI, 53202-5308, US

(73) Assignee: Palm, Inc.

(21) Appl. No.: 10/001,580

(22) Filed: Nov. 1, 2001

(51) Int. Cl. G06G 7/00; G06F 17/00

(52) U.S. Cl. 705/400

(57) ABSTRACT

A system and method for selling or pricing a product is disclosed. The system includes a data collection system configured to collect data relating to the product, and a pricing system in communication with the data collection system. The pricing system is configured to sell or price the product in accordance with the data relating to the product.

### BACKGROUND

The present invention relates generally to methods for product pricing and selling. The present invention more specifically relates to automated processes for product pricing, selling, and disposition.

Current business practices for pricing products such as insurance, warranties, and other similar types of coverage involve risk assessment. The company providing the product (such as an insurance policy or warranty) will review a variety of risk factors to ultimately arrive at a pricing decision. Broadly speaking, the factors may include risk associated with the property or object, risk associated with the customer, risk associated with customer habits, risk associated with amount of usage of the property or object, etc. As an example, a company selling a property insurance policy may look at various risk factors as an approximation of the amount or level of risk to which property is exposed (e.g. determine if the property has an operational sprinkler system, determine if the property has an operational security system, review crime statistics for the surrounding neighborhood, etc.). The company may also look at various risk factors as an approximation of the amount or level of risk associated with the customer (e.g. the number of claims previously filed, previous warranties taken out by the customer, the number of people using the property, etc.). The collected risk information is then compared against known or calculated risk levels (e.g. compared to actuarial tables, calculated risks, etc.). The insurance company can then price the product according to a calculated risk of loss.

Current business practices may be improved to provide more complete and accurate risk assessments. Current business practices presently provide relatively broad risk assessments. Current business practices do not provide for accurate risk assessments. Also, current business practices do not provide for dynamic, changing, or real-time risk assessments. Further, current business practices do not provide for dynamic pricing based on collected data, such as location.

Accordingly, it would be advantageous to provide a system and method which would allow for finer, more accurate risk assessments. It would also be advantageous to provide a system and method which would allow for changing, and/or real-time risk assessments. It would further be advantageous to provide a system and method for pricing or automatically selling a product based on directly observable or calculable personal, individualized, and/or real-time information, and using this information and comparing it to established industry specific tables. Such systems and methods may advantageously provide more accurate calculations of product pricing, higher profits for the provider, lower prices for the customer, etc.

The techniques described below extend to those embodiments which fall within the scope of the appended claims, regardless of whether they provide one or more of the above-mentioned advantageous features.

### SUMMARY

An exemplary embodiment relates to a system for selling or pricing a product. The system includes a data collection system configured to collect data relating to the product, and a pricing system in electronic communication with the data collection system. The pricing system is configured to sell or price the product in accordance with the data relating to the product.

Another embodiment of the present invention relates to a method of calculating a price associated with a risk protection product. The method includes receiving data related to a subject that is associated with the risk protection product. The data is received from a remote location. The method further includes processing the data in accordance with predetermined risk data, and generating the price from the processed data.

Another exemplary embodiment relates to a method for monitoring a product warranty. The method includes monitoring operational data relating to the product, recording the operational data relating to the product, and comparing the operational data to at least one operational specification relating to the product.

Another exemplary embodiment relates to a method for pricing a product. The method includes receiving information via a remote transmitter, and generating the price based on the received information.

Another exemplary embodiment relates to a processing system. The processing system includes a receiver configured to receive data relating to an object at predetermined periodic intervals, a central processing unit (CPU) coupled to the receiver, and a storage device coupled to the CPU. The storage device has stored there information for configuring the CPU to generate correlated data by correlating the received data to actuarial data, and to generate a price in accordance with the correlated data.

Another exemplary embodiment relates to a processing system. The processing system includes a receiver configured to receive data relating to a product at predetermined periodic intervals, a central processing unit (CPU) coupled to the receiver, and a storage device coupled to the CPU. The storage device has stored there, information for configuring the CPU to collect data relating to a warranty, and compare that data to operational warranty data.

### BRIEF DESCRIPTION OF THE DRAWINGS

FIG. 1 is a schematic representation of a data collection system for use in conjunction with a risk assessment system according to an exemplary embodiment;

FIG. 2 is a schematic representation of a data collection system for use in conjunction with a risk assessment system according to an exemplary embodiment;

FIG. 3 is a schematic representation of a data collection system for use in conjunction with a risk assessment system, as applied to a fleet of vehicles, according to an exemplary embodiment; and

FIG. 4 is a schematic representation of a method for pricing a product according to an exemplary embodiment.

### DETAILED DESCRIPTION OF EXEMPLARY EMBODIMENTS

Insurance providers and other product and service providers may require accurate risk information or other types of information, such as but not limited to location information, so they can price their products accordingly. The introduction and widespread adoption of various mobile and wireless technologies allow insurance providers, among others, to implement greatly improved risk assessment abilities. Using these technologies, insurance providers have the potential to use more accurate risk information for use in pricing their products. Also, mobile and wireless communications technologies have enabled dynamic pricing of products.

Insurance providers (referring to those who sell or offer products which protect against risk, including insurance companies, insurance underwriters, warranty providers, as well as other product and service providers, etc.) make decisions relating to risk and risk assessment for the policies they issue, or types of risk coverage they provide. Insurance providers rely on various sets of risk data in making these decisions. Data may include predetermined risk data, as well as data specifically relating to a product or item to be protected.

A first set of risk data that insurance providers rely on may be referred to as predetermined risk data. Such data includes an assortment or compilation of varying types of risk data. Predetermined risk data may include actuarial data or historical risk data which can be used to identify or predict a level of risk exposure. Predetermined risk data (i.e. actuarial, historical, and other types of risk prediction or assessment data) are used in determining the price of the product (i.e. cost of coverage, premium cost, policy cost, etc.). Many times, this type of risk data is compiled into actuarial tables which are consulted for pricing prior to issuing an insurance policy or coverage.

A second set of risk data includes risk factors specifically related to the object to be covered. Such data includes the cost of the object, cost of potential repairs, physical location of the item, usage of the object, etc.

Using a combination of predetermined risk data, and risk factors related to the object, insurance providers price their product. For example, a certain make of vehicle, having specific features, and used primarily in a specific location will have a perceived risk assessment which is derived from the predetermined risk data. Using that data, the insurance provider may then price an insurance policy for that specific vehicle according to their perceived risk assessment.

These two sets of data that insurance providers typically rely on have the disadvantage of not being completely accurate in that both data sets provide a coarse or broad estimate of risk. The data sets are not reflective of the actual level of risk to which the insured item is exposed. Rather, it provides a rough estimate of the risk which the insured item is believed or expected to be exposed.

Integrating wireless and mobile technologies into risk assessment systems and methods offers potential for more accurately assessing risk, and identifying risk levels.

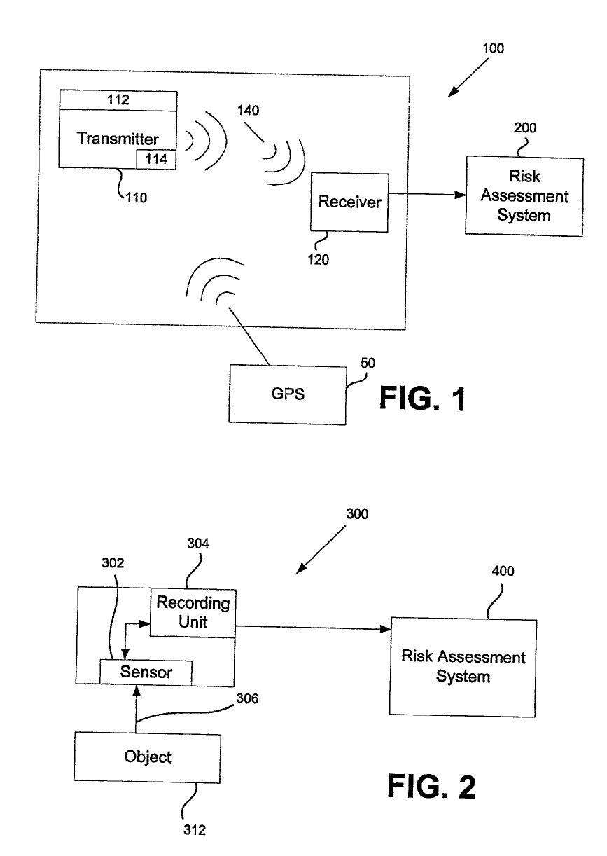

Referring to FIG. 1, an exemplary embodiment of a data collection system 100 for use in conjunction with a risk assessment system 200 is shown. At the outset, it should be noted that risk assessment systems, in addition to those shown and described in the exemplary embodiments, refer broadly to systems and processes (including automated, manual, human, computer, and other systems and processes) used in issuing, providing, selling, pricing, etc. risk protection products (such as policies, warranties, instruments, coverage plans, etc. relating to risk coverage, insurance policies, warranties, underwriting, etc.). Further, the risk assessment systems shown and described may be applied to the invention as a pricing system for providing dynamic pricing of products based on data collected from a mobile electronic device.

According to an exemplary embodiment, system 100 includes a transmitter or a transceiver 110, a receiver or transceiver 120, and data 140. Transceiver or transmitter 110 may be incorporated into a handheld computer, or incorporated into or attached to an object or person of interest. Transmitter or transceiver 110 may be an IEEE 802.11 transceiver, a Bluetooth transceiver, a cellular telephone, transceiver, or the like. Receiver 120 may be a standard IEEE 802.11 access point, a Bluetooth access point, a cellular telephone receiver, or the like. Alternatively, other models, types and configurations of transmitters, transceivers, and/or receivers may be used.

Transmitter 110 and receiver 120 are configured to communicate with, and to transfer data (shown as data 140) with each other. In an exemplary embodiment, transmitter 110 and receiver 120 communicate and transmit data 140 according to an IEEE 802.11 protocol, a Bluetooth protocol, CDMA, TDMA, GSM, or the like.

In a preferred embodiment, transmitter 110 is a wireless transmitter configured to be attached to an object or person to be insured (shown as object 112). For example, transmitter 110 may be configured to attach to a watch, a vehicle, other tangible personal property, objects, etc.

Transmitter 110 may further include a location receiver 114. Location receiver 114 receives a signal representative of location. Location receiver 114 may receive the signal from a position signal or location signal, such as a signal from a global positioning system (shown in FIG. 1 as GPS 50), including a GPS satellite system. Alternatively, location receiver 114 may use a variety of position signals to track the position of transmitter 110 and object 112 such as radio frequency (RF) triangulation, cellular tower location, access point location, etc.

Transmitter 110 transmits data 140 to receiver 120. In a preferred embodiment, data 140 includes information relating to the location of the transmitter (and object 112), such as data received from location receiver 114. Alternatively, data 140 may include information relating to the time and date, the temperature and other weather or environmental conditions factors and/or information, a personal identifier, time of use information, personal user information, etc. In an exemplary embodiment, data 140 is transmitted to receiver 120 every 10 minutes. Alternatively, data may be transmitted or updated according to any desired interval. For example, data may be transmitted continuously, hourly, daily, weekly, monthly, etc.

Receiver 120 receives data 140 at a location remote from transmitter 110. Data 140 may then be passed to risk assessment system 200 by a variety of ways, including via computer, network, internet, intranet, manually, via recording media such as diskette, recordable compact disks such as CD-R, and CD-RW, tape drive, cables, cabling, data links, wireless transmitters, etc.

Risk assessment system 200 uses data 140 to provide an updated risk assessment associated with object 112. For example, by providing continuous location data (as part of data 140) to risk assessment system 200, risk assessment system 200 may continuously update the risk to object 112 based on location. If object 112 is located in a high-risk location (as defined by historical or actuarial data), the price for insurance that an insurance provider charges may go up in accordance with the perceived risk assessment. Correspondingly, if object 112 is located in a low-risk location (as defined by historical or actuarial data), the price for insurance that that insurance provider charges may go down in accordance with the perceived risk assessment. Risk assessment system 200 uses predetermined risk data and data 140 to arrive at a pricing decision for object 112. This pricing decision may be continuous or done at specified intervals, and updated based on the changing location of object 112.

By providing updated risk data to risk assessment system 200, insurance providers have a more accurate, updated ability to assess risks to object 112, and price the product accordingly.

In an alternative embodiment, system 100 may record data 140 for later use, transmission, or input into risk assessment system 200.

Referring to FIG. 2, an exemplary embodiment of a data collection system 300 for use in conjunction with a risk assessment system 400 is shown. System 300 may be attached or associated with a device, object, machine, etc. (shown as object 312). In an exemplary embodiment, object 312 may be a computer system such as a desktop computer, laptop computer, handheld computer, etc. Alternatively, object 312 may be a variety of other objects which are to be monitored, such as automobiles, vehicles, machinery, electronic equipment, appliances, or any other type of object which may have a risk protection product associated with the object.

System 300 includes sensor 302 and recording unit 304. Sensor 302 is configured to monitor object 312. Sensor 302 is configured to monitor the parameters relevant to the risk protection product (e.g. a warranty, insurance policy, etc.) associated with object 312.

For example, a warranty issued by an insurance provider may specify that a certain object (such as a central processing unit (CPU) of a computer system) must never be operated outside of preset operational parameters or operational specifications (such as temperature, humidity, hours of operation, time between service, etc.). Alternatively, a warranty issued by an insurance provider may specify that a vehicle must be serviced according to a predetermined time or mileage schedule. Sensor 302 is configured to monitor the selected operational parameters.

Sensor 302 may be a plurality of sensors configured to monitor a plurality of operational parameters. Sensor 302 may update according to any preferred time interval (continuously, hourly, daily, etc.).

Sensor 302 passes sensed or operational data 306 to recording unit 304. Recording unit 304 preserves data 306 for later use, review or analysis by risk assessment system 400. In an exemplary embodiment, recording unit 304 may be any of, but not limited to, a disk drive, optical drive, flash memory, etc. Data 306 may be passed to risk assessment system 400 by a variety of ways, including via computer, network, internet, intranet, manually, via recording media such as diskette, recordable compact disks such as CD-R and CD-RW, tape drive, cables, cabling, data links, wireless transmitters, etc.

In an alternative embodiment, risk assessment system 400 may further include data monitoring or data recording systems for receiving data from system 300. Data may be transmitted continuously, or according to any preferred updating schedule.

Risk assessment system 400 may receive data 306 for review and assessment. For example, risk assessment system 400 may review data 306 to ensure that object 312 has been operated in accordance with operational parameters or operational specifications specified in a warranty-type coverage. A warranty issued by an insurance provider may specify that object must never be operated outside of a certain temperature range. If, after review of data 306, it is found that object 312 was operated outside of the temperature range, the warranty may be voided, or other corrective action may be taken upon review of data 306.

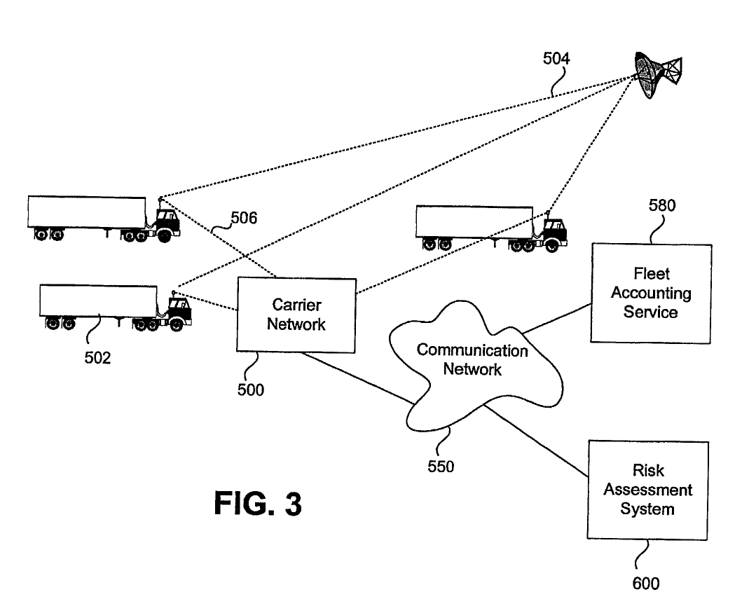

Referring to FIG. 3, an exemplary embodiment of a data collection system (shown as a carrier network 500) for use in conjunction with a risk assessment system 600 is shown. The carrier network 500 may be used in conjunction with a fleet of vehicles such as a fleet of transport trucks, taxis, rental cars, etc. Vehicle 502 is configured to transmit its individual location (as received from a GPS location signal 504, or similar signal) via data signal 506, to carrier network 500. Carrier network 500 may be a cellular network, radio network, or other data communications network. Carrier network 500 is configured to receive multiple data signals 506 from the numerous vehicles in a vehicle fleet. Data signal 506 may alternatively include a wide variety of other data types including service history, pressure, temperature, weather conditions, etc.

The data collection system 500 is in communication with a communication network 550. Communication network 550 links carrier network 500, a fleet accounting system 580, and risk assessment system 600.

Risk assessment system 600 receives location information 506 via carrier network 500 and communication network 550, and makes pricing decisions for the fleet of vehicles relating to insurance pricing, etc. Fleet accounting service 580 is coupled to risk assessment system 600 via communication network 550, allowing fleet accounting service 580 to pay or transfer funds to the product provider in response to a pricing decision made by risk assessment system 600.

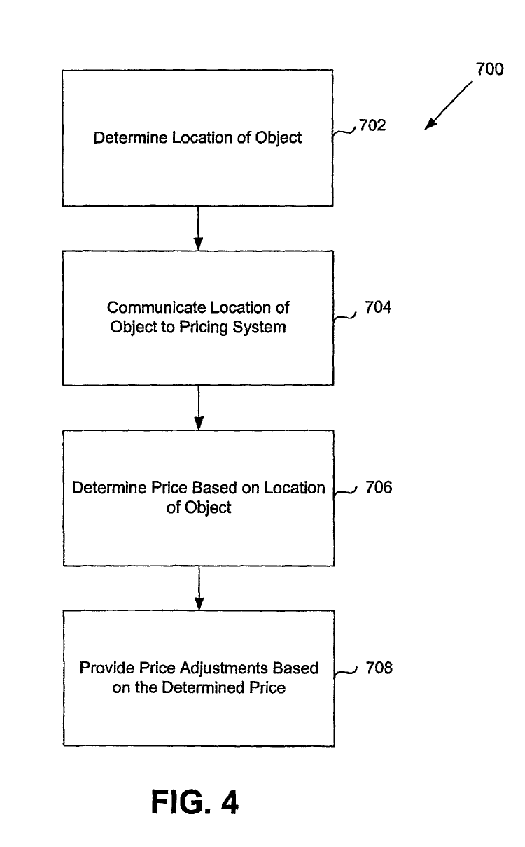

Referring to FIG. 4, a method for pricing a product (such as an insurance policy or other product, including but not limited to information products and service products) for an object (such as a handheld computer) is shown. The location of the object is determined (shown as step 702). The location of the object is then communicated to a pricing system (shown as step 704). A determination or quantification of the product price is then made based on the location of the object (shown as step 706). Based on the determination or quantification of risk, need, demand, supply, and the like, price adjustments are made (shown as step 708).

Alternatively, the method shown in FIG. 4 may be applied to a wide variety of objects, items, people, etc. for a variety of products such as warranties, insurance policies, map information, tourist information, transportation services, delivery services, etc.

While the detailed drawings, specific examples, construction, arrangements, and particular formulations given describe exemplary embodiments, they serve the purpose of illustration only. Although only a few embodiments of the present inventions have been described in detail in this disclosure, those skilled in the art who review this disclosure will readily appreciate that many modifications are possible without materially departing from the novel teachings and advantages of the subject matter recited. For example, in alternative embodiments, the systems and methods described may be further configured to sell various products. For example, the risk assessment system 200 (shown in FIG. 1) may be configured to sell a product such as an insurance policy based on data 140 received from transmitter 110. It may be agreed upon that if object 112 enters a “high-risk” area, risk assessment system 200 will automatically purchase insurance coverage for object 112. Accordingly, all such modifications are intended to be included within the scope of the present inventions. Furthermore, other substitutions, modifications, changes, and omissions may be made in the design, operating conditions, and arrangement of the exemplary embodiments without departing from the scope of the invention as expressed in the appended claims.

What is claimed is:

1. A system for selling or pricing a product, the system comprising:
a data collection system configured to collect data relating to the product; and
a pricing system in electronic communication with the data collection system, the pricing system configured to sell or price the product in accordance with the data relating to the product.

2. The system of claim 1, wherein the pricing system is in electronic communication with the data collection system via wireless transmitter.

3. The system of claim 2, wherein the data relating to the product is location data.

4. The system of claim 1, wherein the data relating to the product is location data.

5. The system of claim 1, wherein the data relating to the product is data relating to at least one selected operational parameter.

6. The system of claim 1, wherein the data collection system further comprises a data storage system.

7. The system of claim 6, wherein the data storage system is configured to communicate with the pricing system.

8. The system of claim 1, wherein the product is an insurance policy.

9. The system of claim 1, wherein the product is a warranty.

10. A method of calculating a price associated with a risk protection product, the method comprising:
receiving data related to a subject that is associated with the risk protection product, the data received from a remote location;
processing the data in accordance with predetermined risk data; and
generating the price from the processed data.

11. The method of claim 10, wherein receiving data further comprises receiving data at predetermined intervals.

12. The method of claim 10, wherein receiving data from a remote location further comprises receiving data from a remote transmitter.

13. The method of claim 12, wherein the remote transmitter is a wireless transmitter.

14. The method of claim 13, wherein the remote transmitter is a wireless location transmitter.

15. The method of claim 10, wherein the data related to the subject further comprises data related to at least one of location, security system status, fire protection system status, crime statistics, environmental conditions, usage time, time of day, and day of year.

16. A method for monitoring a product warranty relating to a product, the method comprising:
monitoring operational data relating to the product;
recording the operational data relating to the product; and
comparing the operational data to at least one operational specification relating to the product.

17. The method of claim 16, wherein the operational data is at least one of temperature data, time between service, pressure, mileage between service, humidity, user, time of day, and day of year.

18. A method for pricing a product, the method comprising:
receiving information relating to the product via a remote transmitter;
generating the product price based on the received information.

19. The method of claim 18, wherein receiving information further comprises receiving information at predetermined intervals.

20. The method of claim 18, wherein the remote transmitter is a wireless transmitter.

21. The method of claim 18, wherein the received information includes location information.

22. The method of claim 21, wherein the remote transmitter is a wireless location transmitter.

23. The method of claim 18, wherein the product is at least one of an insurance policy, an insurance premium, an insurance price, and a warranty price.

24. A processing system comprising:
a receiver configured to receive data relating to a product at predetermined periodic intervals;
a central processing unit (CPU) coupled to the receiver; and
a storage device coupled to the CPU, and having stored there information for configuring the CPU to
generate correlated data by correlating the received data to actuarial data, and
generate a price in accordance with the correlated data.

25. A processing system comprising:
a receiver configured to receive data relating to an object at predetermined periodic intervals;
a central processing unit (CPU) coupled to the receiver; and
a storage device coupled to the CPU, and having stored there information for configuring the CPU to
collect operational specification data relating to a warranty, and
compare the received data relating to the object, to the operational specification data relating to the warranty.
